(19) United States
(12) Patent Application Publication
(10) Pub. No.: US 2004/0103060 A1
(43) Pub. Date: May 27, 2004

(54) Secure payment system and method having one-time use authorization

(75) Inventors: Thomas J. Foth, Trumbull, CT (US); John G. Desmond, Fairfield, CT (US); Cindy Mangiameli, Southbury, CT (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 10/302,016

(22) Filed: Nov. 22, 2002

(51) Int. Cl. G06F 17/60

(52) U.S. Cl. 705/40

(57) ABSTRACT

A payment system and method is provided. A buyer establishes an account with the payment system. The buyer makes a request for payment for a transaction to the payment service. The request includes information related to the transaction. The payment system processes the information related to the transaction and issues a payment approval identification number. At the point of sale, access to the payment system is gained utilizing an access device not associated with the buyer, and information related to transaction and the identification number are provided to the payment system. The payment system will verify the information provided at the point of sale related to the transaction with the information provided by the buyer when payment was authorized. If the identification number is verified by the payment system, funds for the transaction will be passed from the buyer's account directly to the merchant's account.

### FIELD OF THE INVENTION

The invention disclosed herein relates generally to the field of payment systems, and more particularly to a system and method for securely transferring funds between two parties utilizing a third party intermediary.

### BACKGROUND OF THE INVENTION

A buyer of purchased goods or services currently has several options to pay for the goods, including, for example, payment instruments such as cash, check, transaction cards (debit or credit), etc. In many situations, the buyer will personally present the payment instrument to the merchant. This provides the buyer with secure control of the payment instrument, and ensures the buyer of an accurate accounting of the payment instrument and the knowledge that it was used as intended. In many situations, however, a third party intermediary, e.g., an agent, will process the transaction with the merchant on behalf of the buyer. In this situation, the buyer must provide the payment instrument to the agent, along with any associated security codes, if necessary, with the expectation that the agent will use the payment instrument only as directed by the buyer. This puts the buyer at risk of losing any funds associated with the payment instrument should an unscrupulous agent fail to follow the buyer's directions. If the payment instrument is a check or cash, the risk to the buyer is the amount of cash or the amount specified on the check. If the payment instrument is a blank check, or a transaction card issued to the buyer, the risk to the buyer significantly increases, as the buyer will have no)way to limit the amount of funds the agent now has access to in case of fraudulent use of the blank check, or transaction card.

One attempt at a security measure to address this issue is described in U.S. Pat. No. 6,052,675, which is directed to preauthorizing a credit card for a particular transaction that is contemplated to occur in the future. In anticipation of a transaction, the credit card owner provides the bank with the owner's account number and requested network data or vendor information. Then, during the transaction approval process, the vendor transmits the account number and requested network data to the bank for verification, If the network data requested of the user and the network data received from the vendor match, then the transaction is approved. Otherwise, the transaction is not approved.

Although this security measure adds a degree of increased security, it suffers from disadvantages and drawbacks. Specifically, the credit card owner must still provide either the actual credit card or the credit card number to an agent that will be processing the transaction on behalf of the owner. Accordingly, this will not reduce all aspects of fraud. For example, if the bank requests that the owner input the location (city/town, state) of the vendor, then a lost or stolen credit card may still be successfully used by an unscrupulous person in that location. In addition, unscrupulous people may get access to the owner's credit card data (name, bank, account number, etc.) even if the agent carefully protects the card. This occurs because the credit card data is often openly available, e.g., printed on receipts and bank statements that may be viewed by unintended people.

One example in which agents may be used to transact business on behalf of a buyer is with permit mail. Permit mail is especially suited for mailers that have large volumes of mail, since permit mail does not require the mailer to place one or more stamps on a mail piece, which can be labor intensive. With permit mail, instead of using stamps, the mailer prints a permit imprint, known as an indicia, on each mail piece. The permit mail is brought to a postal induction site, referred to by the United States Postal Service (USPS) as a Bulk Mail Entry Unit (BMEU), by the mailer, or an agent of the mailer. The mailer also prepares forms indicating the number of mail pieces in the mailing and the amount of postage estimated to be due. For manifest mail, a sampling of the mailing is performed at the induction site for comparison with the manifest provided by the mailer to determine the accuracy of the estimates made by the mailer. For uniform mail (mail of uniform size and weight), the number of mail pieces in the mailing is verified by the postal authority. For example, verification can be performed by weighing ten mail pieces and, based on the ten mail pieces actually weighed, determining the average single piece weight. The entire mailing is then weighed, and the total weight is divided by the average single piece weight to determine the total number of mail pieces in the mailing. The postage due is then calculated based on the average single piece weight and the total number of mail pieces as determined by the postal authority. The mailer, or his agent, must provide payment for the total amount of postage due as determined by the postal authority. Such payment can be, for example, in the form of a check, cash, uncancelled stamps, or debit from a trust account into which money must be wired. The USPS also provides certain mailers with a postage payment system referred to as the Centralized Account Processing System (CAPS), which provides electronic options to presenting checks or cash in person. CAPS utilizes either a centralized trust account, in which funds are deposited electronically, via standard Automated Clearing House (ACH) banking mechanisms, to the CAPS bank prior to inducting the mailing, or a centralized debit account, in which the mailer's designated bank account will be debited, via standard ACH banking mechanisms, for the total of the day's mailings on the next business day. CAPS, however, is only available to mailers that meet specified minimum criteria and thus cannot be utilized by small or mid-sized mailers.

There are problems, however, with the conventional systems for paying for permit mail. For example, if the mailer is paying by cash, check, or uncancelled stamps, payment must be presented at the time the mailing is inducted by the postal authority. Accordingly, the mailer or agent presenting the mailing for induction must have either the correct amount of cash or uncancelled stamps, or a check for the correct amount, as determined by the verification or comparison performed by the postal authority. Typically, if there is a discrepancy less than some predetermined threshold, such as, for example, 1.5%, the postal authority will accept the amount of the payment as estimated by the mailer. However, if the discrepancy between what the mailer estimated as the amount of postage believed to be due and the amount due as calculated by the postal authority is greater than the threshold limit defined by the postal authority, the party presenting the mailing may either have insufficient cash or uncancelled stamps to pay for the mailing, or a check for the incorrect amount, i.e., either more or less than required. Discrepancies are fairly common, especially for uniform mailings having thousands, or tens of thousands, of mail pieces. With such large mailings, the entire mailing is weighed by rolling carts, including the trays containing the mail pieces, onto a large scale, and then subtracting a standardized weight for the carts and trays, to determine the total weight of the mailing. The weight of the carts and trays typically changes over time, as labels may be added, pieces may be missing, etc. Thus, it is quite possible that a discrepancy will occur due to the inherent inaccuracy of such a system. In addition, if the mailer failed to prepare the mail appropriately for claimed discounts, such as, for example, improperly sorting the mail or not providing readable barcodes on each piece, the postage amount for the mailing will be upgraded to reflect the true nature of the mailing and any discounts. If the delivery person for the mailer does not have the authority to draft a new check for the correct amount, either higher or lower, or immediate access to additional cash or uncancelled stamps to pay the postage due if higher than estimated by the mailer, the mailing will be rejected.

In addition to the above problems, payment in the form of cash or a check adds processing costs for the postal authority. For example, it takes additional time and expenses to record and account for payments made in this manner. Since funds are collected in a distributed fashion, it is possible for funds to get misplaced and/or checks to get lost.

As noted above, there is also an issue with the security of the payment instrument, i.e., cash, uncancelled stamps, or check, if the party presenting the mailing to the USPS for induction cannot be completely trusted (perhaps because the party presenting the mailing is simply a third party courier).

Thus, there exists a need for a payment system and method that reduces the risk of loss for a buyer when the buyer utilizes an agent to process the transaction, reduces transaction processing for the merchant, and provides a buyer with secure control over the use of funds for a specific transaction.

### SUMMARY OF THE INVENTION

The present invention alleviates the problems associated with the prior art and provides a payment system and method that reduces the risk of loss for a buyer when the buyer utilizes a third party intermediary to process the transaction, reduces transaction processing for the merchant, and provides the buyer with secure control over the use of funds for a specific transaction.

In accordance with the present invention, a payment system is provided to securely transfer funds. A buyer establishes an account with the payment system. The account could be set up, for example, as an interest bearing or non-interest bearing deposit account from which funds may be used to pay for authorized transactions. Additionally, the payment system could establish a credit line for the buyer. The payment system can issue transaction cards, similar to a debit card, to the buyer and one or more agents. Alternatively, the present invention could utilize existing transaction cards (debit cards or credit cards) issued by financial institutions.

When the buyer decides to make a purchase, a request for payment on behalf of the buyer is made to the payment service. The request includes information related to the purchase transaction, such as, for example, the specific items or category of items included in the transaction, the estimated cost of the transaction, a range of dates during which the transaction will occur, an identification of the merchant where the transaction will occur or a specific category of merchants where the transaction will occur, and, if an agent will be used to perform the transaction on behalf of the buyer, an identification of the agent. The buyer authorizes the payment system to provide the specified merchant (or any merchant within the specified category) with payment for the transaction, upon completion of the transaction, on the buyer's behalf based on this information. The payment system processes the information related to the transaction and issues a payment approval identification number (PAIN) for the transaction. The PAIN is a one-time use authorization number specific to the transaction. The PAIN may be cryptographically generated over a sufficiently wide range of integer values such that it would be difficult for an unauthorized party to guess the number assigned to a transaction with the attributes previously specified.

The PAIN can be provided to an agent that will be processing the transaction. According to the present invention, a transaction card issued to the agent can be used to process the transaction. At the point of sale, access to the payment system is gained by passing the agent's transaction card through a card reading terminal. Information related to the merchant identification (or merchant category), the specific transaction, such as, for example, the price, product, service, etc., and the PAIN are provided to the payment system. The payment system will compare the information provided at the point of sale related to the merchant and the transaction with the information provided by the buyer when payment was authorized, utilizing the PAIN. If the PAIN is verified by the payment system, funds for the transaction will be passed from the buyer's account directly to the merchant's account via the transaction card presented by the agent. Thus, the transaction card used by the agent does not have access to any of the buyer's funds other than those for the specific transaction authorized by the buyer., Additionally, since the agent's transaction card is utilized to process the transaction and funds merely flow through the agent's transaction card, i.e., the funds are not removed from an account of the agent, the agent does not need to use the buyer's transaction card. Thus, the buyer does not need to provide the agent with a transaction card issued to the buyer.

Once the funds have been transferred from the buyer's account to the merchant's account and the transaction is complete, the buyer can settle the account with the payment system (if necessary). The payment system of the present invention provides buyers with multiple payment options including “Just-In-Time” payments, “Pay In Advance” payments, and/or “Pay In Arrears” payments. The “Just-In-Time” payment option allows the buyer to pay the payment service at the time the transaction is completed. The “Pay In Arrears” payment option provides the buyer with a credit line to pay for transactions. The “Pay In Advance” payment option may provide buyers with interest on funds stored in anticipation of transactions.

All of the payment solutions of the present invention allow the buyer to view all of their account detail on-line, including historical payment information, initiate on-line payments, and initiate and approve on-line authorizations. Buyers can make payments to the payment system in a number of ways, including, for example, via check, ACH credit or debit or wire.

### DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 illustrates in block diagram form a payment system according to the present invention;

FIGS. 2A and 2B illustrate in flow diagram form processing for the payment of a transaction according to the present invention;

FIG. 3 illustrates in block diagram form an exemplary account for payment of transactions according to the present invention; and

FIG. 4 illustrates in block diagram form a payment system for permit mail according to the present invention.

### DETAILED DESCRIPTION OF THE PRESENT INVENTION

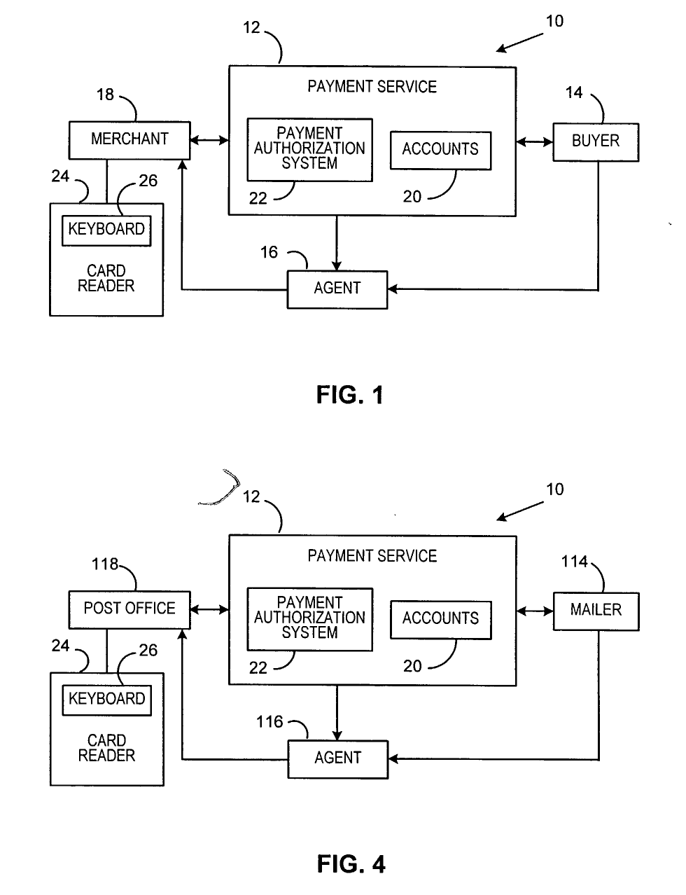

In describing the present invention, reference is made to the drawings, wherein there is seen in FIG. 1 a payment system 10 according to the present invention. System 10 includes a payment service 12 that enables a buyer 14 to conduct transactions and make payments to a merchant 18 utilizing a third party intermediary, such as an agent 16, while minimizing the risk of loss of funds for the transaction. Payment service 12 is preferably a computer-based system comprising any combination of conventional processors, memory, software, hardware, firmware, etc. Agent 16 may be a third party separate from buyer 14 or may be an internal agent, such as, for example, an employee, of buyer 14. Payment service 12 maintains one or more accounts 20 for buyer 14 as described below. Payment service 12 also includes a payment authorization system 22 to generate a one-time authorization number for a transaction requested by the buyer 14 as described below. Optionally, merchant 18 can be provided with a card reader 24, having a keypad 26, to access the payment service 12 as described below.

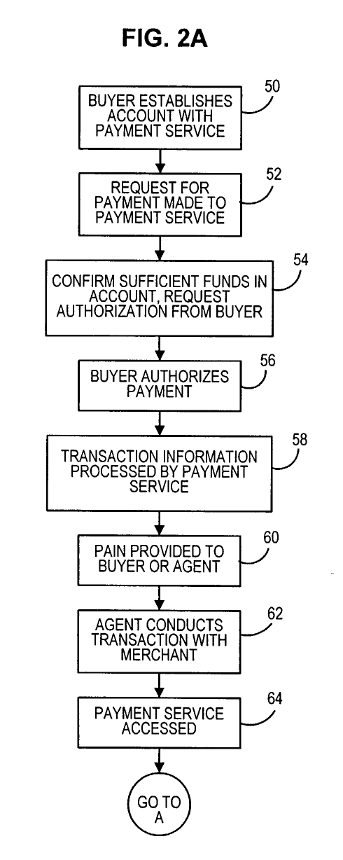

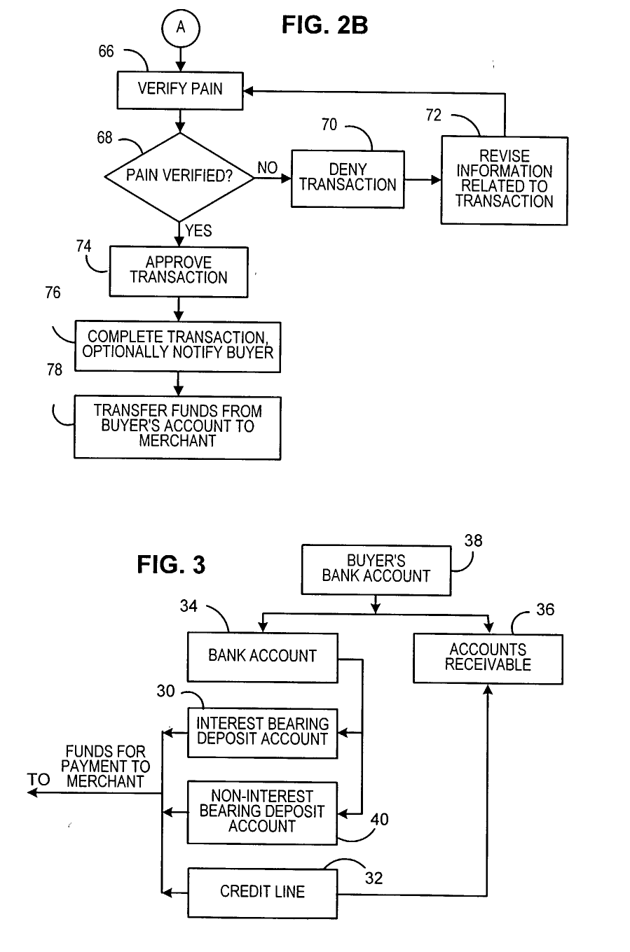

The operation of system 10 will be described with respect to the flow diagrams illustrated in FIGS. 2A and 2B. In step 50, a buyer 14 establishes an account 20 with the payment service 12 to provide services related to payment for transactions authorized by buyer 14 and conducted by or on behalf of the buyer 14. Such transactions could include, for example, the purchase of goods or services from a merchant 18. This account 20 for buyer 14 can be established in a number of different ways as illustrated in FIG. 3. Payment service 12 can establish an interest bearing deposit account 30 and/or a non-interest bearing deposit account 40 for buyer 14 from which funds may be used to pay the merchant 18 as described below. Interest bearing deposit account 30 allows the buyer 14 to accumulate interest on any funds deposited in interest bearing deposit account 30. Funds for the interest bearing deposit account 30 or non-interest bearing deposit account 40 for buyer 14 can be provided by transferring funds, in any convenient manner, such as, for example, by wire transfer, check, ACH credit, etc., from the buyer's bank account 38 to a bank account 34 of payment service 12. These funds are then transferred to the interest bearing deposit account 30 or non-interest bearing deposit account 40. Alternatively to, or in addition to, interest bearing deposit account 30 and/or non-interest bearing deposit account 40, payment service 12 could also establish a credit line 32 for buyer 14 if desired. Payments made to a merchant 18 on behalf of the buyer 14 via the credit line 32 are billed to the buyer 14 by the accounts receivable department 36 of payment service 12, which then receives payment from the buyer 14, typically from the buyer's bank account 38. Additionally, the interest bearing deposit account 30, non-interest bearing deposit account 40 and/or credit line 32 could be maintained by buyer 14 utilizing a telephone dial-up system or network (not shown). Thus, the present invention provides buyer 14 with multiple payment options including “Just-In-Time” payments, “Pay In Advance” payments, and/or “Pay In Arrears” payments. The “Just-In-Time” payment option allows the buyer 14 to pay the payment service 12 at the time of a transaction with a merchant 18 utilizing an ACH debit transaction from an account, external to payment service 12, associated with the buyer 14, such as, for example, a checking account maintained by a financial institution for the buyer 14. The “Pay In Arrears” payment option provides the buyer 14 with a credit line 32 to pay for transactions with a merchant 18. The “Pay In Advance” payment option may provide buyer 14 with interest on pre-paid authorized transactions. All of the payment solutions of the present invention allow the buyer 14 to view all of their account detail on-line via a remote computer coupled to a network, such as, for example, the Internet. Account details include, for example, historical payment information, initiate online payments, and initiate and approve on-line authorizations.

Referring again to FIG. 2A, suppose, for example, buyer 14 decides to conduct a transaction with merchant 18, utilizing an agent 16, in which payment must be made to merchant 18. In step 52, a request for payment for the transaction is made to the payment service 12. Such request could be made in any conventional manner, such as, for example, by telephone, via a web page operated by payment service 12 and accessed by buyer 14, facsimile, e-mail, etc. The request includes information related to the transaction, such as, for example, an identification of the specific merchant 18 or a merchant code that identifies a specific category in which merchant 18 must belong, an identification of the specific goods or category of goods to be purchased in the transaction, utilizing, for example, a product SKU Number or UPC code, the anticipated amount of the payment for the transaction, a range of dates during which the transaction will occur, and an identification of the agent 16 that will be used to process the transaction with the merchant 18 on behalf of the buyer 14, utilizing, for example, an alpha-numeric identification number or the like. This information is utilized to limit the availability of funds to a transaction having similar attributes as the provided information.

Optionally, in step 54, payment service 12 can confirm that the account 20 of the buyer 14 has sufficient funds to cover the cost of the transaction (if the account 20 does not include a credit line 32 (FIG. 3)), and then confirm the request made by the buyer 14 by requesting the buyer 14 to specifically authorize payment for the transaction based on the information received in step 52. According to the present invention, payment service 12 can also provide the buyer 14 with a “not to exceed” price for the transaction based on statistics and other information related to discrepancies between previous estimated cost of transactions and the actual cost of the transactions. This allows the buyer 14 to pre-authorize an increase in the cost, as long as the cost does not exceed the specified limit, should a discrepancy be found. This eliminates the need for the buyer 14 to be contacted if a slight discrepancy is found, which could unnecessarily delay completion of the transaction. Of course, if desired, buyer 14 could also change the “not to exceed” cost provided by payment service 12 to a higher or lower level or the buyer 14 can specify a percentage of the total estimated cost to add to the estimated cost to derive a “not to exceed” price.

In step 56, the buyer 14 provides authorization for payment associated with the transaction. Such authorization could be provided in any conventional manner, such as, for example, by telephone, via a web page operated by payment service 12 and accessed by buyer 14, facsimile, e-mail, etc. With respect to responses by telephone, it should be noted that buyer 14 could provide authorization utilizing a voice recognition unit (VRU). Of course, if the buyer 14 is making the request for payment, then such authorization could be given along with the request in step 52 and thus steps 54 and 56 may not need to be performed. Once authorization for payment has been provided by the buyer 14, the funds for the transaction will be entered against the account 20 for buyer 14; however, no funds will be removed from the account 20 of buyer 14, or in the case of a credit account buyer 14 will not be billed for the funds, until the transaction has been completed.

Once authorization for payment has been provided by buyer 14, in step 58 the information related to the transaction is processed by payment service 12. According to one embodiment of the present invention, processing includes the generation of a Payment Approval Identification Number (PAIN) by a payment authorization system 22 (FIG. 1). The PAIN can be, for example, a randomly or cryptographically generated number that is linked to information that identifies the transaction for which the buyer 14 has authorized payment. The information can include, for example, an identification of the specific merchant 18 or a merchant code that identifies a specific category in which merchant 18 must belong, an identification of the goods or category of goods to be purchased in the transaction, the anticipated amount of the payment for the transaction, a “not to exceed” cost for the transaction, a range of dates during which the transaction will occur, and an identification of the agent 16 that will be used to process the transaction with the merchant 18 on behalf of the buyer 14. Thus, the PAIN is a one-time use authorization number specific to the transaction.

In step 60, the PAIN is provided to the buyer 14 or agent 16. The PAIN can be provided to the buyer 14 by payment service 12, and the buyer 14 can then inform the agent 16 of the PAIN, or, alternatively, the payment service 12 can provide the PAIN directly to the agent 16, since identification of the agent 16 is provided to the payment service 12 by the buyer 14 in step 52. Buyer 14 can request agent 16 to utilize a transaction card (credit or debit) issued to the agent 16 by payment service 12 or other financial institution. Thus, the buyer 14 does not have to provide any funds to the agent 16 or provide the agent 16 with a transaction card issued to the buyer 14 to process the transaction as will be described below. Accordingly, system 10 provides a trusted third party system for the payment of a transaction when conducted by agent 16 on behalf of buyer 14.

According to another embodiment of the present invention, instead of generating a PAIN, the information related to the transaction is simply stored by payment service 12 in a location associated with the buyer 14 for accessing as will be described below.

In step 62, the agent 16 goes to the merchant 18 to process the transaction. At the point of sale, typically the site of the merchant 18, access to the payment service 12 is obtained utilizing an access device not issued or associated with the buyer, such as, for example, by reading a transaction card (debit or credit) issued to the agent 16, presented by the agent 16 in step 64. Reading of the card can be performed utilizing any type of conventional card reader 24 (FIG. 1). Alternatively, card reader 24 can be a specialized card reader provided by payment service 12 for use only with the payment system 10. Alternatively, access to the payment service 12 could be obtained utilizing a radio frequency identification tag (RF ID tag) and associated reader or biometric data of the agent 16 or merchant 18. Also in step 64, the merchant 18, or alternatively the agent 16, can input information specific to the transaction being processed and the PAIN issued by the payment service 12. Inputting of the information specific to the transaction can be performed automatically in the same manner as approvals for conventional debit or credit card transactions are done. Thus, for example, the identification of the merchant 18 and/or the merchant code that identifies the specific category in which merchant 18 belongs, an identification of the goods being purchased in the transaction, the amount of the required payment for the transaction, the date of the transaction, and an identification of the agent 16 can be automatically sent to the payment service 12 from the point of sale processing unit coupled to the card reading device (or RF ID tag reading device or biometric data reading device) at the site of the merchant 18. Alternatively, information specific to the transaction can be input via an input device, such as, for example, a keypad 26, on the card reader 24 or other reading device. The PAIN may also be input by the agent 16 or merchant 18 via keypad 26 on the card reading device 24. Alternatively, of course, the merchant 18 can contact the payment service 12 directly, such as, for example, by telephone, and provide the identification of the merchant 18 and/or the merchant code that identifies the specific category in which merchant 18 belongs, an identification of the specific goods or category of goods being purchased in the transaction, the amount of the required payment for the transaction, the date of the transaction, the identification of the agent 16, and the PAIN to the payment service 12.

It should be noted that access to the payment service 12 in step 64 will be different depending upon the type of transaction card used by the agent 16. Thus, for example, if the transaction card is a debit card issued by the payment service 12, access will be directly to the payment service 12 for verification of the PAIN as described below. If the transaction card used by the agent 16 is a debit card issued by a financial institution other than payment service 12, a PIN will be required to access any funds in an account maintained at the financial institution that is associated with the debit card. If the PAIN input does not match the PIN, the financial institution that issued the debit card will send the information to the payment service 12 for verification of the PAIN as described below. Thus, the present invention can utilize the existing framework and point of sale terminals presently used to authorize conventional debit card purchases. If the transaction card used by the agent 16 is a credit card issued to the agent 16, input of the PAIN will cause the credit card issuer to transfer the information to the payment service 12 for verification of the PAIN as described below. Alternatively, access to the payment service can be accomplished utilizing a debit card issued by the payment service 12, followed by entry of the PAIN and the credit card issued to the agent 16. Furthermore, as described above, access to the payment service 12 could be obtained utilizing a radio frequency identification tag (RF ID tag) and associated reader or biometric data of the agent 16 or merchant 18.

Once the payment service 12 has been accessed and the information specific to the transaction and the PAIN have been provided to the payment service 12, the payment service 12 will verify the information specific to the transaction against the PAIN in step 66. Alternatively, instead of the merchant 18 providing all of the information specific to the transaction being conducted to the payment service 12, the payment service 12 can send the information associated with the PAIN to the merchant 18, and the merchant 18 can perform verification of the PAIN against the transaction being conducted. Verification of the PAIN provides security for the buyer 14 that only a transaction pre-authorized by the buyer 14 will occur. The verification procedure optionally comprises several steps, each of which provides security against one or more types of fraudulent activities. For example, in step 66, it is determined if the agent 16 attempting to process the transaction has the authority to process the transaction on behalf of the buyer 14. This is performed by verifying the identification of the agent 16 as provided by the buyer 14 in step 52 with the identification of the agent 16 actually conducting the transaction as provided when the payment service 12 is accessed in step 64. Thus, for example, even if access to the payment system 12 is obtained and a lost or stolen PAIN provided, without knowing the proper identification of the agent 16 no approvals for any transactions will be granted. In step 66, the PAIN is also verified by ensuring that the PAIN as provided by the agent 16 is a valid PAIN, i.e., was properly issued by the payment service 12. Thus, for example, if an unscrupulous agent attempts to make a purchase utilizing funds in the account 20 of the buyer 14 by providing an invalid PAIN, no approvals for any transactions will be granted by payment service 12.

Also in step 66, the PAIN is verified by comparing the information specific to the transaction being processed with the information related to the transaction as provided by the buyer 14 in step 52. Thus, for example, the identification of the specific merchant 18 or a merchant code that identifies a specific category in which merchant 18 must belong, an identification of the specific goods or category of goods to be purchased in the transaction, the amount of the payment for the transaction or the not to exceed price, and the date of the transaction will be compared with the information provided by the buyer 14 in step 52. Thus, even if an agent 16 has possession of a valid PAIN, the agent 16 can only make a transaction authorized by the buyer 14, i.e., for a specific item or from a specified type of merchants, for a specified amount and during a specified range of dates. The PAIN cannot be used by the agent 16 for any other purpose, thereby reducing fraudulent activity.

Thus, multiple safeguards are provided by payment system 12 to the buyer 14 to ensure that payment will be made only for a transaction already authorized by the buyer 14. In order for the transaction to be approved by the payment service 12, several criteria must be met. The agent 16 must be properly identified, the agent 16 must provide a valid PAIN, and the specifics of the transaction must be similar to those as pre-approved by the buyer 14. In step 68 it is determined if the PAIN is verified as described above. If the PAIN is not verified in step 68, then in step 70 the payment service 12 will not approve payment for the transaction and the merchant 18 should not complete the transaction with the agent 16. For example, if one or more of the agent 16 is not correctly identified, the merchant 18 is not correct, the specific goods or category of goods being purchased are not correct, the cost of the transaction exceeds the “not to exceed price” authorized by the buyer 14, the date is not valid, etc., payment service 12 will deny the transaction. Optionally, in step 72, the buyer 14 can be contacted in real time to revise the information related to the transaction, such as, for example, the “not to exceed price” or date or otherwise fix the problem that resulted in the PAIN not being verified. Thus, a new PAIN could be immediately issued by payment service 12, and the transaction processed again utilizing the newly issued PAIN. Alternatively, of course, the original PAIN could simply be reissued by payment service 12 and the transaction processed again using the reissued PAIN. Another safeguard provided by the payment system 12 to the buyer 14 is the ability of the buyer 14 to cancel the PAIN at any time prior to the transaction being authorized. Thus, the buyer 14 can prevent a previously authorized transaction from occurring at any time before the transaction has actually occurred.

Alternatively, if a PAIN is not generated by payment system 12, the merchant 18 can communicate with the payment service 12 and provide the information specific to the transaction as described above along with an identification of the buyer 14. Payment system 12 can then review all of the transactions for which payment has been authorized by buyer 14 to determine if the transaction currently being processed has been authorized by the buyer 14.

If in step 68 it is determined that the PAIN is verified, then in step 74 approval for the transaction is provided by the payment service 12 to the merchant 18. Such approval indicates to the merchant 18 that payment will be made by the payment service 12, and the merchant 18 can allow the transaction to proceed. In step 76, the merchant 18 and agent 16 can complete the transaction, and the payment service 12 can optionally provide notification to the buyer 14 that the transaction has been completed. Such notification could be done, for example, by an automated telephone system, facsimile, e-mail, etc. This provides independent verification that an authorized transaction has been completed by the agent 16 on behalf of the buyer 14 on a specified date.

In step 78, the payment system 12 transfers funds from an account 20 of the buyer 14 to the merchant 18. Such transfer can occur similar to a conventional debit card or credit card payment. Recall that at the time the buyer 14 provided authorization for the transaction in step 56, it was not necessary to move money from the account 20 of the buyer 14. Thus, the buyer 14 has not occurred any type of finance charges or fees if the payment is being done utilizing the credit line 32, nor has the buyer 14 lost any interest from money being removed from the interest bearing deposit account 30.

The transfer of funds flows from the account 20 of buyer 14 maintained by payment service 12 to the merchant 18 via the transaction card utilized by the agent 16. Thus, no funds have been removed or debited against the actual transaction card used by agent 16 to access the payment service 12. This provides benefits to both the buyer 14 and the agent 16. With the present invention, the buyer 14 does not need to provide the agent 16 with a transaction card issued to the buyer 14, or provide cash or a check to the agent 16 to pay for the transaction, thus providing security for any funds of the buyer 14. Instead, the agent 16 can use a transaction cared (debit card or credit card) issued to the agent 16 to access the payment service 12, process the transaction on behalf of the buyer 14, and the funds will be removed from the account 20 of the buyer 14. Thus, the agent 16 does not have to float the cost of the transaction until paid by the buyer 14 should the agent 16 use a transaction card issued to the agent 16 to process the transaction.

Thus, the system 10 of the present invention allows an agent to process a transaction with a merchant on behalf of a buyer, without the buyer having to provide funds to the agent or allow the agent to have direct access to unlimited funds to pay for the transaction. Additionally, the system 10 according to the present invention reduces the amount of record keeping for both buyers and merchants, since all payments are made electronically utilizing a payment service. Since the present invention allows a buyer to have funds released based on use, i.e., for a specific purchase or from a specific category of merchants, it allows the buyer to easily track and fund the account with the payment service. For example, a business could now establish one account for use by several employees. By controlling the release of the funds in the account for only authorized purchases or for use only with a specified category of merchants, fraudulent use of the business's funds can be significantly reduced.

Those skilled in the art will also recognize that various modifications can be made without departing from the spirit of the present invention. For example, the present invention can be used to give a gift to someone instead of providing a gift certificate. In a gift-giving scenario, the buyer 14 in FIG. 1 would be the gift giver, and the agent 16 would be the recipient of the gift. The gift giver can request a payment for a transaction that will be conducted by the recipient in one or more specific categories of merchants, such as, for example, a clothing store, record store, home store, etc. The gift giver can specify the amount of the gift, i.e., transaction amount, that is being authorized, the merchant code(s), date range of use, etc. Upon receipt of the PAIN from the payment service 12, the gift giver can provide the PAIN to the recipient, along with an indication of the value of the gift, i.e., the amount of funds available, and the category of merchants in which the gift can be used, i.e., where transactions are authorized to occur. At the merchant 18, the recipient (or merchant 18) can then access the payment service 12 using a transaction card issued to the recipient, provide the PAIN, and if verified, have the funds for the transaction transferred from the gift giver's account to the merchant 18 similarly as described with respect to FIGS. 2A and 2B. In addition, the gift giver can specify that the PAIN is valid until all funds authorized by the gift giver have been used. Thus, for example, if a $100 gift is being given, the recipient can use the PAIN multiple times until the sum of all transactions is $100. Once the sum of all transactions conducted by the recipient has exceeded $100, the PAIN will become invalid and no more funds will be available from the gift giver's account.

The present invention can also be utilized to allow a third party to deposit money into an account 20 maintained by the payment service 12 for a person without having to divulge any sensitive information related to the account 20, such as, for example, the account number. Payment service 12 can establish a shadow number, different from the actual account number, for an account 20 that allows only deposits to be made to account 20. Thus, if a person maintained an account 20 with the payment service, and a third party wanted to make a gift to that person, the third party could be given the shadow number and make a deposit to the account 20. Since the shadow number allows only deposits to be made, the account 20 will still be secure. In addition, by utilizing the shadow number, any party can make a deposit to the account 20, even third parties that are not registered with or have their own account with the payment service 12.

Similarly, the present invention can be utilized by merchants, such as merchant 18, to provide rebate programs to a buyer 14 without having to issue rebate cards or checks. In the rebate program scenario, a merchant performs the functions of both the merchant 18 and buyer 14 in FIG. 1, while the consumer receiving the rebate would perform the functions of the agent 16 in FIG. 1 but will get to keep the goods or services purchased in the transaction. Thus, a merchant 18 can establish an account with the payment service 12 and make requests for payment for a transaction that can be conducted only at that merchant 18. The merchant 18 can specify the amount of the transaction that is being authorized, i.e., the “rebate,” date range of use, etc. Upon receipt of the PAIN from the payment service 12, the merchant 18 can provide the PAIN to the consumer, i.e., agent 16, along with an indication of the value of the “rebate”, i.e., the amount of funds available, and the date range of use. The agent 16 can then conduct transactions with the merchant 18, using the PAIN provided by the merchant 18 and any debit or credit card that provides access to the payment service 12. As long as the criteria for the transaction being conducted is verified against the PAIN, the transaction can be completed and funds for the transaction will be transferred from the account of the merchant 18 at the payment service 12 to the merchant 18. Thus, the consumer, i.e., agent 16, will not be charged for the transaction. In addition, the merchant 18 can specify that the PAIN is valid until all funds authorized by the merchant 18 have been used.

As another example, the present invention can be used to monitor and limit the use of funds in an account. For example, a parent could now provide a dependent child with access to funds, but only on a limited basis and for specified items or from a specified category or merchants. Thus, instead of giving a college bound child a credit card or debit card issued to the parent, a parent can utilize the present invention to provide the child with limited access to funds via the PAIN and a debit card issued to the child by the payment service. For example, the parent can provide the child with a specific amount of funds to be used in the college bookstore or a food store for only specific items, such as, for example, books or food, as opposed to compact discs or alcoholic beverages. The child can access the payment service using the child's transaction card. Of course, the transaction card will not be valid for use except for transactions authorized by the parent. This will prevent the parent from having to send money to the child, or constantly add money to an account that the child has unlimited access to, while enabling the parent to monitor the child's spending.

As another example, the present invention can be utilized to provide security for transactions conducted between the buyer 14 and merchant 18 over a network, such as, for example, a telephone network or the Internet. In accordance with the present invention, the buyer 14 will not need to provide a credit card or debit card number over the network, thus maintaining security and privacy of the buyer's card. Utilizing the present invention in this scenario, the merchant 18 would also act as an agent 16 for the buyer 14. The buyer 14 can make a request for payment for a transaction to be conducted with the merchant 18. The request can include information related to the purchase transaction, such as, for example, the specific items or category of items included in the transaction, the estimated cost of the transaction, a range of dates during which the transaction will occur, and an identification of the merchant 18 where the transaction will occur. The buyer authorizes the payment system to provide the specified merchant 18 with payment for the transaction, upon completion of the transaction, on the buyer's behalf based on this information. The payment service 12 processes the information related to the transaction and issues a payment approval identification number (PAIN) for the transaction.

Upon conducting the transaction with the merchant 18, the buyer 14 will provide the PAIN to the merchant 18. The merchant 18 can then access the payment service 12, utilizing a debit or credit card issued to the merchant 18, for verification of the PAIN with the transaction being conducted. If the PAIN is verified by the payment service 12, the merchant can complete the transaction and funds for the transaction will be passed from the buyer's 14 account directly to the merchant's 18 account via the transaction card utilized by the merchant 18. Thus, the buyer 14 does not need to send a credit card or debit card number to the merchant 18 via the network, but instead needs only to provide the PAIN to the merchant 18. Since the PAIN is specific to only to a transaction that will be conducted with the merchant 18, it will have no value should its security be compromised when being transported via the network.

Another example of a use of present invention is for the payment of permit mail as illustrated in FIG. 4. FIG. 4 is similar to FIG. 1, except a mailer 114 replaces the buyer 14, and a post office 118 replaces the merchant 18. The processing of a transaction for permit mail is similar to that as described with FIGS. 2A and 2B, and will not be repeated again in full detail. Briefly, the processing for permit mail is as follows. A mailer 114 establishes an account with payment service 12 to provide services related to payment for transactions, including permit mail that will be sent by the mailer 114. When the mailer 114 will be sending a batch of permit mail, a request for payment for the permit mail is made to the payment service 12. The request includes information related to the mailing, such as, for example, the induction site where the mailing will be inducted, the permit imprint number under which the mail will be inducted, a range of dates during which the mail will be inducted, the number of pieces (or a maximum number of pieces) of mail to be inducted, the estimated cost of the mailing, the return address on the mailing, and the identification of an agent 116 that will be delivering the mailing for induction to the post office 118. This information is utilized to limit the availability of funds to a mailing having similar attributes as the provided information.

Optionally, payment service 12 can ensure sufficient funds are available in the account 20 of the mailer 114, and request the mailer 114 to specifically authorize payment for the mailing based on the information received from the mailer 114. Once authorization for payment has been provided by the mailer 114, the funds for the permit mail will be entered against the account 20 for mailer 114; however, no funds will be removed from the account 20 of mailer 114, or in the case of a credit account mailer 114 will not be billed for the funds, until the transaction has been completed, i.e., the mailing has been inducted by the USPS.

Once authorization for payment has been provided by mailer 114, the information related to the mailing is processed by payment service 12, and payment service 12 generates a PAIN. The PAIN can be, for example, a randomly or cryptographically generated number that is linked to information that identifies the mailing for which the mailer 114 has authorized payment. The information includes, for example, the induction site where the mailing will be inducted, the permit imprint number under which the mail will be inducted, a range of dates during which the mail will be inducted, the number of pieces (or a maximum number of pieces) of mail to be inducted, the estimated cost of the mailing, the return address on the mailing, and the identification of an agent 116 that will be delivering the mailing for induction to the post office 118. Thus, the PAIN is a one-time use authorization number specific to that mailing.

The PAIN is then provided to the mailer 114, or, alternatively, an agent 116 that will be delivering the mailing to the post office 118. For example, agent 116 could be a lettershop that was used to prepare the mailing, a third-party delivery service, or an employee of mailer 114. The mailing is then delivered by the agent 116 to the post office 118 for induction. At the induction site, i.e., post office 118, the PAIN is presented, along with the mailing, to a postal clerk who then communicates with the payment service 12. Access to the payment service 12 is obtained, utilizing a transaction card issued to the agent 116 (or to a postal employee) as previously described, and the PAIN is provided to the payment service 12. Payment service 12 then provides the postal clerk with the information that identifies the mailing for which the mailer 114 has authorized payment that is linked to the PAIN, including, for example, the induction site where the mailing will be inducted, the permit imprint number under which the mail will be inducted, a range of dates during which the mail will be inducted, the number (or maximum number) of pieces of mail to be inducted, the estimated cost of the mailing, including the “not to exceed” cost authorized by the mailer 16, and the return address on the mailing. The postal clerk also determines the actual postage cost for the mailing (verification as previously described), and then the postal clerk compares the mailing as presented for induction to the information provided by the payment service 12.

The postal clerk then determines if the mailing as presented meets each of the criteria provided by the payment service 12. Alternatively, the postal clerk could provide payment service 12 with information specific to the mailing as presented, and the payment service 12 could perform the comparison between the specific mailing as presented and the information provided by the mailer 114 for generating the PAIN. If it is determined that the mailing as presented does not meet each of the criteria for the mailing based on the information associated with the PAIN, then authorization for payment will not be granted and the mailing will be rejected by the post office 118 and not inducted into the mail system. For example, if the induction site where the mailing will be inducted is incorrect, or the permit imprint number under which the mail will be inducted is incorrect, or the mail is not being presented within the range of dates specified, or the number of pieces of mail to be inducted is incorrect, or the actual cost will exceed the “not to exceed” cost authorized by the mailer 114, or the return address on the mailing is incorrect, the mailing will be rejected.

If the mailing is rejected because it does not meet one or more of the criteria for the mailing, then according to the present invention the mailer 114 can revise the criteria in real-time, such as, for example, the “not to exceed price” or otherwise fix the problem that caused the mailing to be rejected and re-present the mailing to the post office 118 for a new comparison. Thus, a new PAIN could be immediately issued by payment service 12, and the mail re-presented to the post office 118, or the mailing could be fixed to fit within the criteria specified for the original PAIN. Alternatively, the mailer 114 could approve a change in the criteria stored by payment service 12. In this case, when the mail is re-presented to the post office 118, the postal clerk would receive the revised criteria which presumably would allow the postal clerk to accept the mail.

If it is determined that the mailing as presented meets the criteria as specified by the mailer 114 for generation of the PAIN, then authorization for payment will be granted and the transaction can be completed, i.e., the mailing can be inducted into the mail system. Optionally the payment service 12 can provide notification to the mailer 114 that the mailing has been inducted into the mail system. The payment system 12 will then transfers funds from an account 20 of the mailer 114 to the post office 118 via the card utilized by the agent 116.

The present invention can also be utilized if a secondary or even tertiary agent, not known to the buyer at the time of authorization of the transaction, is used to process the transaction. For example, using the permit mail example given above, it is possible that the mailing will be delivered for induction (ether by the mailer 114 or an agent 116 known to the mailer 114) but will not be inspected and inducted until some later time such that the party making the delivery will no longer be at the post office 118. Thus, at the actual time of inspection and induction it will be necessary to access the payment service 12 to verify the PAIN issued for that mailing. However, if the mailer 114 or agent 116 that was identified by the mailer 114 when authorizing the transaction is not present, the PAIN will not be verified. According to another embodiment of the present invention, a postal clerk at the post office 118 can act as a secondary agent for the mailer 114 as follows.

When the mailing is delivered to the post office 118 (either by the mailer 114 or an agent 116 authorized by the mailer 114), the PAIN will be verified, and the transaction will be identified as being a “delayed transaction,” i.e., the transaction will not be completed until some later time using a secondary agent. Payment service 12 will then issue a pre-authorization code that associates the transaction authorized by the buyer 114 with the post office 118. The pre-authorization code acts as a secondary PAIN. At this time, however, no funds will be removed or charged to the account 20 of the buyer 114. When the mailing is verified and the actual cost determined at some later time, a postal clerk accesses the payment service 12, using a transaction card issued to the post office 118, and provides the pre-authorization number and the specific details of the transaction, i.e., the actual cost, etc. The payment service 12 will then verify the pre-authorization code against the information provided by the mailer 114 for generation of the original PAIN, and, if it is determined that the mailing as presented meets the criteria as specified by the mailer 114, authorization for payment will be granted and the transaction can be completed, i.e., the mailing can be inducted into the mail system.

The payment system 12 will then transfer funds from an account 20 of the mailer 114 to the post office 118 via the transaction card utilized by the post office 118. Thus, even though the mailer 114 may not have known the specifics with respect to the identification of the post office 118 when authorizing the transaction, the post office 118 can still be utilized as an agent by the mailer 114 to complete the transaction. It should be understood, of course, that use of a secondary, tertiary, etc. agent according to the present invention is not limited to transactions occurring with the post office 118, but can also be utilized for transactions with any merchant.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description.

What is claimed is:

1. A method of operating a payment service to provide funds to pay for a transaction between a buyer and a merchant, the method comprising:
receiving at the payment service a request from the buyer for payment for the transaction, the request including information related to the transaction;
processing the information related to the transaction;
upon processing of the transaction, granting access to the payment service via an access device not associated with the buyer;
receiving information specific to the transaction;
verifying the information specific to the transaction with the information related to the transaction; and
if the information specific to the transaction is verified with the information related to the transaction, providing funds from the payment service to the merchant to pay for the transaction.

2. The method according to claim 1, wherein before receiving a request, the method further comprises:
establishing at least one payment account for the buyer from which the funds for the transaction will be provided upon verification of the information specific to the transaction with the information related to the transaction.

3. The method according to claim 2, wherein the at least one payment account includes an interest bearing deposit account.

4. The method according to claim 2, wherein the at least one payment account includes a non-interest bearing deposit account.

5. The method according to claim 2, wherein the at least one payment account includes a credit account.

6. The method according to claim 1, wherein the information related to the transaction includes at least one of an identification the merchant, a merchant code that identifies a specific category in which the merchant must belong, an identification of specific goods or services to be purchased in the transaction, a category of goods or services from which the goods or services being purchased in the transaction must belong, an anticipated amount of funds for the transaction, a range of dates during which the transaction will occur, and an identification of an agent that will be used to process the transaction.

7. The method according to claim 1, wherein after receiving a request from the buyer, the method further comprises:
requesting authorization from the buyer to pay for the transaction.

8. The method according to claim 1, wherein verifying further comprises:
comparing the information specific to the transaction with the information related to the transaction.

9. The method according to claim 1, wherein processing the information further comprises:
generating an identification number associated with the transaction, the identification number being linked with the information related to the transaction; and
providing the identification number for use in processing the transaction.

10. The method according to claim 9, wherein providing the identification number further comprises:
providing the identification number to the buyer that requested payment for the transaction.

11. The method according to claim 9, wherein providing the identification number further comprises:
providing the identification number to an agent for the buyer that requested payment for the transaction.

12. The method according to claim 9, wherein receiving information specific to the transaction further comprises:
receiving the identification number associated with the transaction.

13. The method according to claim 12, wherein verifying further comprises:
comparing the information related to the transaction linked with the identification number with the information specific to the transaction.

14. The method according to claim 1, wherein processing the information further comprises:
storing the information related to the transaction in a location identified by information related to the buyer.

15. The method according to claim 14, wherein verifying further comprises:
comparing the information related to the transaction stored in the location identified by the information related to the buyer with the information specific to the transaction.

16. The method according to claim 1, wherein if funds are provided to pay for the transaction, the method further comprises:
providing confirmation of the providing of funds for payment to the buyer.

17. The method according to claim 1, wherein an agent is used to process the transaction on behalf of the buyer, and the information related to the transaction includes an identification of the agent.

18. The method according to claim 17, wherein receiving information specific to the transaction further comprises:
receiving an identification of the agent processing the transaction.

19. The method according to claim 18, wherein verifying further comprises:
comparing the identification of the agent that is authorized to process the transaction with the identification of the agent that is processing the transaction.

20. The method according to claim 1, wherein an agent is used to process the transaction, and the access device is a transaction card associated with the agent.

21. The method according to claim 1, wherein an agent is used to process the transaction, and the access device is a radio frequency identification tag associated with the agent.

22. The method according to claim 1, wherein an agent is used to process the transaction, and the access device utilizes biometric data associated with the agent.

23. The method according to claim 1, wherein the access device is a transaction card associated with the merchant.

24. The method according to claim 1, wherein the access device is a radio frequency identification tag associated with the merchant.

25. The method according to claim 1, wherein the access device utilizes biometric data associated with the merchant.

26. The method according to claim 1, wherein the transaction is processed over a network.

27. A method for a mailer to provide funds to a postal service to pay for a mailing comprising:
receiving at a payment service a request from the mailer for payment for the mailing, the request including information related to the mailing;
processing the information related to the mailing;
upon induction of the mailing at an induction site, granting access to the payment service via an access device not associated with the mailer;
providing the information related to the mailing to the induction site; and
if the information related to the mailing is verified with the information specific to the mailing, providing funds from the payment service to the postal service to pay for the mailing.

28. The method according to claim 27, wherein before receiving a request, the method further comprises:
establishing at least one payment account for the mailer from which the funds for the mailing will be provided upon verification of the information related to the mailing with the information specific to the mailing.

29. The method according to claim 27, wherein the information related to the mailing includes at least one of an induction site where the mailing will be inducted, a permit imprint number under which the mailing will be inducted, a range of dates during which the mailing will be inducted, a number of pieces included in the mailing, an estimated cost of the mailing, a return address on the mailing, and an identification of an agent delivering the mailing to the induction site.

30. The method according to claim 27, wherein processing the information further comprises:
generating an identification number associated with the mailing, the identification number being linked with the information related to the mailing.

31. The method according to 30, wherein providing the information related to the mailing further comprises:
receiving the identification number associated with the mailing from the induction site; and
providing the information related to the mailing linked with the identification number to the induction site.

32. The method according to claim 27, wherein processing the information further comprises:
storing the information related to the mailing in a location identified by information related to the mailer.

33. The method according to claim 32, wherein providing the information related to the mailing further comprises:
providing the information related to the mailing stored in the location identified by the information related to the mailer to the induction site.

34. The method according to claim 27, further comprising:
providing confirmation of the providing of funds for payment to the mailer.

35. The method according to claim 27, wherein an agent is used to deliver the mailing to the induction site, and the access device is a transaction card associated with the agent.

36. The method according to claim 27, wherein an agent is used to deliver the mailing to the induction site, and the access device is a radio frequency identification tag associated with the agent.

37. The method according to claim 27, wherein an agent is used to deliver the mailing to the induction site, and the access device utilizes biometric data associated with the agent.

38. The method according to claim 27, wherein the access device is a transaction card associated with the postal service.

39. The method according to claim 27, wherein the access device is a radio frequency identification tag associated with the postal service.

40. The method according to claim 27, wherein if the information related to the mailing is not verified with the information specific to the mailing, the method further comprises:
receiving revised information related to the mailing from the mailer; and
providing the revised information related to the mailing to the induction site.

41. A method for operating a payment service to provide funds to a postal service to pay for a mailing for a mailer comprising:
receiving at the payment service a request from the mailer for payment for the mailing, the request including information related to the mailing;
processing the information related to the mailing;
upon induction of the mailing at an induction site, granting access to the payment service via an access device not associated with the mailer;
receiving information specific to the mailing from the induction site;
verifying the information specific to the mailing with the information related to the mailing; and
if the information specific to the mailing is verified with the information related to the mailing, providing funds from the payment service to the postal service to pay for the mailing.

42. The method according to claim 41, wherein before receiving a request, the method further comprises:
establishing at least one payment account for the mailer from which the funds for the mailing will be provided upon verification of the information related to the mailing with the information specific to the mailing.

43. The method according to claim 41, wherein the information related to the mailing includes at least one of an induction site where the mailing will be inducted, a permit imprint number under which the mailing will be inducted, a range of dates during which the mailing will be inducted, a number of pieces included in the mailing, an estimated cost of the mailing, a return address on the mailing, and an identification of an agent delivering the mailing to the induction site.

44. The method according to claim 41, wherein processing the information further comprises:
generating an identification number associated with the mailing, the identification number being linked with the information related to the mailing.

45. The method according to 41, wherein receiving the information specific to the mailing further comprises:
receiving the identification number associated with the mailing from the induction site.

46. The method according to claim 41, wherein processing the information further comprises:
storing the information related to the mailing in a location identified by information related to the mailer.

47. The method according to claim 41, further comprising:
providing confirmation of the providing of funds for payment to the mailer.

48. The method according to claim 41, wherein an agent is used to deliver the mailing to the induction site, and the access device is a transaction card associated with the agent.

49. The method according to claim 41, wherein the access device is a transaction card associated with the postal service.

50. A method for inducting permit mail comprising:
receiving a mailing associated with a mailer for induction at an induction site;
accessing a payment service utilizing an access device not associated with the mailer;
receiving information related to the mailing from the payment service, the information including criteria for the mailing;
determining if the mailing received for induction meets the criteria included in the information related to the mailing received from the payment service;
accepting the mailing for induction if the mailing received for induction meets the criteria included in the information related to the mailing received from the payment service; and
receiving payment for the mailing from the payment service.

51. The method according to claim 50, wherein the information related to the mailing includes at least one of an induction site where the mailing will be inducted, a permit imprint number under which the mailing will be inducted, a range of dates during which the mailing will be inducted, a number of pieces included in the mailing, an estimated cost of the mailing, a return address on the mailing, and an identification of an agent delivering the mailing to the induction site.

52. The method according to claim 50, wherein accessing the payment service further comprises:
providing an identification number associated with the mailing to the payment service, the identification number being linked with the information related to the mailing.

53. The method according to claim 50, wherein an agent is used to deliver the mailing to the induction site, and the access device is a transaction card associated with the agent.

54. The method according to claim 50, wherein an agent is used to deliver the mailing to the induction site, and the access device is a radio frequency identification tag associated with the agent.

55. The method according to claim 50, wherein the access device is a transaction card associated with the postal service.

56. The method according to claim 50, wherein the access device is a radio frequency identification tag associated with the postal service.

57. The method according to claim 50, wherein the access device utilizes biometric data.

58. A method for a merchant to provide a rebate program comprising:
requesting from a payment service payment for a transaction associated with the rebate program, the request including information related to the transaction;
receiving from the payment service an identification number associated with the transaction;
providing the identification number to a customer;
receiving the identification number back from the customer upon processing of the transaction;
accessing the payment service utilizing an access device not associated with the customer;
providing the identification number and information specific to the transaction to the payment service for verification; and
if the identification number and information related to the transaction are verified, receiving funds from the payment service to pay for the transaction,
wherein the customer does not provide any funds to pay for the transaction.

59. The method according to claim 58, wherein the access device is a transaction card associated with the merchant.

60. The method according to claim 58, wherein the access device is a radio frequency identification tag associated with the merchant.

61. The method according to claim 58, wherein the access device utilizes biometric data.

62. The method according to claim 58, wherein the information related to the transaction includes at least one of a maximum amount of the transaction and a range of dates during which the transaction must be processed.

63. A system to provide funds to pay for a transaction between a buyer and a merchant, the system comprising:
a payment service, the payment service receiving a request from the buyer for payment for the transaction, the request including information related to the transaction, the payment service processing the information related to the transaction, the payment system upon processing of the transaction providing access via an access device not associated with the buyer; and
at least one payment account for the buyer,
wherein the payment service receives information specific to the transaction and verifies the information specific to the transaction with the information related to the transaction, and if the information specific to the transaction is verified with the information related to the transaction, provides funds from the at least one payment account for the buyer to the merchant to pay for the transaction.

64. The system according to claim 63, wherein the at least one payment account includes an interest bearing deposit account.

65. The system according to claim 63, wherein the at least one payment account includes a non-interest bearing deposit account.

66. The system according to claim 63, wherein the at least one payment account includes a credit account.

67. The system according to claim 63, wherein an agent is used to process the transaction, and the access device is a transaction card associated with the agent.

68. The system according to claim 63, wherein an agent is used to process the transaction, and the access device is a radio frequency identification tag associated with the agent.

69. The system according to claim 63, wherein an agent is used to process the transaction, and the access device utilizes biometric data associated with the agent.

70. The system according to claim 63, wherein the access device is a transaction card associated with the merchant.

71. The system according to claim 63, wherein the access device is a radio frequency identification tag associated with the merchant.

72. The system according to claim 63, wherein the access device utilizes biometric data associated with the merchant.

73. The system according to claim 63, wherein the transaction is processed over a network.

74. The system according to claim 63, further comprising:
a first account number associated with the at least one payment account; and
a second account number associated with the at least one payment account,
wherein the second account number allows access to the at least one payment account only for deposits to the at least one payment account.

75. A payment service to provide funds to pay for a transaction between a buyer and a merchant, the payment service comprising:
means for receiving a request from the buyer for payment for the transaction, the request including information related to the transaction;
means for processing the information related to the transaction;
means for granting access to the payment service via an access device not associated with the buyer;
means for receiving information specific to the transaction;
means for verifying the information specific to the transaction with the information related to the transaction; and
if the information specific to the transaction is verified with the information related to the transaction, means for providing funds from the payment service to the merchant to pay for the transaction.

76. The payment service according to claim 75, further comprising:
means for establishing at least one payment account for the buyer from which the funds for the transaction will be provided upon verification of the information specific to the transaction with the information related to the transaction.

77. The payment service according to claim 76, wherein the at least one payment account includes an interest bearing deposit account.

78. The payment service according to claim 76, wherein the at least one payment account includes a non-interest bearing deposit account.

79. The payment service according to claim 76, wherein the at least one payment account includes a credit account.

80. The payment service according to claim 75, wherein the information related to the transaction includes at least one of an identification the merchant, a merchant code that identifies a specific category in which the merchant must belong, an identification of specific goods or services to be purchased in the transaction, a category of goods or services from which the goods or services being purchased in the transaction must belong, an anticipated amount of funds for the transaction, a range of dates during which the transaction will occur, and an identification of an agent that will be used to process the transaction.

81. The payment service according to claim 75, wherein the means for verifying further comprises:
means for comparing the information specific to the transaction with the information related to the transaction.

82. The payment service according to claim 75, wherein the means for processing the information further comprises:
means for generating an identification number associated with the transaction, the identification number being linked with the information related to the transaction; and
means for providing the identification number for use in processing the transaction.

83. The payment service according to claim 75, wherein the means for processing the information further comprises:
means for storing the information related to the transaction in a location identified by information related to the buyer.

84. The payment service according to claim 83, wherein the means for verifying further comprises:
means for comparing the information related to the transaction stored in the location identified by the information related to the buyer with the information specific to the transaction.

85. The payment service according to claim 75, wherein an agent is used to process the transaction on behalf of the buyer, and the information related to the transaction includes an identification of the agent.

86. The payment service according to claim 75, wherein an agent is used to process the transaction, and the access device is a transaction card associated with the agent.

87. The payment service according to claim 75, wherein an agent is used to process the transaction, and the access device is a radio frequency identification tag associated with the agent.

88. The payment service according to claim 75, wherein an agent is used to process the transaction, and the access device utilizes biometric data associated with the agent.

89. The payment service according to claim 75, wherein the access device is a transaction card associated with the merchant.

90. The payment service according to claim 75, wherein the access device is a radio frequency identification tag associated with the merchant.

91. The payment service according to claim 75, wherein the access device utilizes biometric data associated with the merchant.

92. The payment service according to claim 75, wherein the transaction is processed over a network.
